(19) United States
(12) Patent Application Publication
(10) Pub. No.: US 2014/0238942 A1
(43) Pub. Date: Aug. 28, 2014

(54) PROCESS OF PURIFYING A RESIDUE WITH CALCIUM IONS

(71) Applicants: Frédéric Nicolas, Haraucourt (FR); Francis Grosjean, Dombasle-Sur-Meurthe (FR); Emeline Gravier, Nancy (FR); Jean-Yves Seguin, Rosieres Aux Salines (FR)

(72) Inventors: Frédéric Nicolas, Haraucourt (FR); Francis Grosjean, Dombasle-Sur-Meurthe (FR); Emeline Gravier, Nancy (FR); Jean-Yves Seguin, Rosieres Aux Salines (FR)

(73) Assignee: SOLVAY SA, Brussels (BE)

(21) Appl. No.: 14/112,613

(22) PCT Filed: Apr. 18, 2012
(86) PCT No.: PCT/EP2012/057077

§ 371 Date: May 15, 2014

(30) Foreign Application Priority Data
Apr. 20, 2011 (EP) 11163262.6

(51) Int. Cl. B01D 9/00

(52) U.S. Cl. CPC B01D 9/0022
USPC 210/726

(57) ABSTRACT

The present invention relates to a process of purifying a residue from an industrial process using calcium ions to obtain a purified brine, comprising: (a) mixing the residue comprising sulfate salts from the industrial process with calcium salts; (b) separating insoluble species and/or precipitates from the suspension from (a); (c) adding one or more selected from C0₂, carbonates, bicarbonates, hydrogen carbonates or fluorinated salts into the filtrate from (b) to remove excess calcium ions; and (d) separating precipitates from the suspension from (c) to obtain a purified brine. Strontium and/or barium salts, which typically exist in the residue, may also be removed from the residue by using the present process. According to the present method, calcium ions are effectively removed from the brine. Thus, a deposition of calcium ions on devices, which are used in the further processes such as crystallization or electrolysis, can be avoided. At the same time, the amount of barium and strontium ions in the brine is reduced significantly. As such, the purified brine can be simply achieved with high purity and low cost in an industrial scale.

### TECHNICAL FIELD

The present invention which claims priority to EP patent application N° 11163262.6 filed on Apr. 20, 2011 the whole content of which is incorporated herein by reference for all purposes relates to a process of purifying a residue from an industrial process using calcium ions, for the purifying treatment, wherein the residue is particularly obtained from rice hull ashes, ashes of wood combustion plants, ashes of coal combustion plants, cement kiln dusts, steel industry dusts, dusts from iron sintering processes, flue dusts from furnace such as glass furnace or cotton processing dusts. The present invention also relates to a process of removing excess alkali earth metal ions remained in brine and recycling the insoluble or removed species.

### BACKGROUND

Residues from many industrial processes contain soluble salts, which make the disposal of these residues more difficult and expensive. This is because such soluble salts may leak out and contaminate subsoil of the disposal site.

Particularly, representatives of such salts are alkali metal salts, especially potassium and/or sodium salts. The alkali metal salts often remain in the form of a mixture of different alkali metal salts, for example, a mixture of alkali metal chloride and alkali metal sulfate.

Thus, it would be desirable to have processes, which make it possible to remove sulfates contained in industrial residues with high purity and low cost in an industrial scale. It would be more desirable to have processes that make it possible to remove two or more different salts from the residue.

International Patent Application WO 2011048135 discloses a process that recycles the soluble salts contained in some industrial residue, particularly to recycle potassium chloride or sodium chloride. Said WO 2011048135 corresponds to application N°. PCT/EP2010/065783, which was unpublished at the date of filing of the above-mentioned EP patent application N° 11163262.6 and which was filed in the name of Solvay SA, the entire content of which is incorporated herein by reference. It has been found that the disposal of residue, which contains valuable raw materials for the above-mentioned industrial processes, particularly cement manufacture, is highly uneconomical.

U.S. Pat. No. 1,402,173, the entire content of which is incorporated herein by reference, discloses a process of obtaining potassium chloride, which is particularly applicable to the production of potassium chloride from cement kiln dust, or other flue dust from furnaces such as glass furnaces or the like. In the process, the sulfates of calcium and potassium form the double salt CaSO₄.K₂SO₄.H₂O. By agitating this double salt in water in the presence of calcium chloride, the double salt is broken up and the potassium is obtained in the form of potassium chloride. The potassium chloride is obtained from the solution by fractional crystallization.

U.S. Pat. No. 3,647,395, the entire content of which is incorporated herein by reference, describes a process of recovering alkali metal salts contained in the gases emitted by cement production furnaces. In this process, the vapours of alkali metal salts contained in the gases emitted are condensed and then added to water with the dust from the flue gas. The aqueous solution obtained is separated from the insoluble particles. The latter is then subjected to a succession of dissolving and separating steps. The aqueous solution finally obtained is subjected to a crystallization of the soluble salts.

However, these processes, which require a large number of dissolving and separating steps, are complex and do not make it possible to effectively remove the sulfates. Moreover, the excess alkali earth metal ions, which existed in the original residue or were added into the residue for removing sulfates from the residue, can be deposited into other devices in the next processes such as crystallization or electrolysis. However, this has an undesirable effect upon the devices.

Thus, there is a need for simpler and cheaper processes, which can purify industrial residue, while avoiding the above-described disadvantages of the prior art.

### SUMMARY

The present invention relates to a purification process of the residue containing soluble salts obtained from industrial source, especially residues obtained with the process described in International Patent Application PCT/EP2010/065783 to yield purified brine.

The present inventors invented a simple purification process of the residue, which can remove sulfates initially contained in the residue and obtain a very low concentration of alkali earth metal ions, to undergo further processing such as crystallization or electrolysis.

Consequently, one of the essential features of the invention resides in a process of purifying a residue comprising sulfate salts from an industrial process using calcium ions as purifying agent to obtain a purified brine, which process comprises:
(a) mixing the residue comprising sulfate salts from the industrial process with calcium salts;
(b) separating insoluble species and/or precipitates from the suspension from (a);
(c) adding an agent capable to precipitate calcium salts from the filtrate from (b) preferably selected from one or more of CO₂, carbonates, hydrogen carbonates or fluorinated salts into the filtrate from (b) to remove excess calcium ions; and
(d) separating precipitates from the suspension from (c) to obtain a purified brine.

The residue contains water-soluble salts including water-soluble sulfate salts.

In a preferred embodiment, the sulfate-containing residue is introduced into step a) in the form of an aqueous solution. The amount of the residue dissolved in the aqueous solution may be high up to the saturation concentration. For example, the concentration of the dissolved residue may be equal to or greater than 40% by weight of the total weight of the dissolved solution. It may be equal to or lower than the saturation concentration. Preferably, the term “saturation concentration” denotes the salt with the lowest solubility at a given temperature. This allows for optimal purification of the residue because the solution of the residue to be treated according to the invention contains no solids.

In some embodiments, the sulfate salts are selected from one or more alkali metal salts, preferably, the sulfate salt is potassium sulfate or sodium sulfate. In some embodiments, carbonates, hydrogen carbonates or fluorinated salts are applied as agent to precipitate calcium salts from the filtrate, and at least one of the carbonates, hydrogen carbonates or fluorinated salts are alkali metal salts, for example, alkali metal carbonates such as sodium carbonate or potassium carbonate, alkali metal hydrogen carbonates such as sodium hydrogen carbonate or potassium hydrogen carbonate, alkali metal fluorides such as sodium fluoride or potassium fluoride or a mixture thereof.

In some preferred embodiments, calcium salts are added with an amount of from 1 to 20% by weight, preferably from 2 to 15% by weight, more preferably from 5 to 10% by weight of aqueous solution in step (a).

In some embodiments, the residue may contain one or more species selected from the group consisting of alkali metal salts such as NaCl, KCl, Na₂SO₄, K₂SO₄, and alkali earth metal salts such as strontium or barium salts. The strontium and/or barium salts are also removed in step (c).

In some embodiments, calcium salts are soluble in the aqueous solution. Such salts are preferably calcium halides, and more preferably calcium chloride. The strontium and/or barium salts also are soluble in an aqueous solution. Such salts are preferably strontium and/or barium halides, and more preferably strontium and/or barium chlorides. The residue may contain such calcium salts which are soluble in the aqueous solution.

In some embodiments, calcium salts are insoluble in an aqueous solution. Such salts are preferably selected from one or more of hydroxides, oxides or carbonates. The strontium and/or barium salts can also be insoluble in the aqueous solution, wherein said salts are preferably strontium and/or barium carbonates. In such cases, the process further comprises the step of adding hydrogen halide, preferably hydrogen chloride, into the suspension from step (a) prior to separating. By adding hydrogen halide, insoluble calcium salts, barium salts and strontium salts, e.g. the hydroxides, oxides and carbonates mentioned above, are transformed into soluble halides, especially the respective chlorides, which have a high solubility in water.

In all cases, the type of strontium and/or barium salts is independent from the type of calcium salts.

In some embodiments, the residue originates from rice hull ashes, ashes of wood combustion plants, ashes of coal combustion plants, cement kiln residue, steel industry dusts or dusts from iron sintering processes, flue dusts from furnace such as glass furnace or cotton processing dusts.

In some embodiments, the purified brine is subjected to at least one additional process such as crystallization and electrolysis.

### BRIEF DESCRIPTION OF THE DRAWINGS

FIG. 1 shows a representative scheme of the purification process according to the present invention.

### DETAILED DESCRIPTION

In the present specification, the plural form and the singular form are used interchangeably. Thus, it should be understood that the plural form also includes the singular form and vice-versa.

In the present invention, the alkali earth metal ions used for purifying the residue may be calcium ions. The term “alkali earth metal salt(s)” used herein means any soluble and/or insoluble salts containing alkali earth metal, i.e., calcium, strontium, barium, radium or a combination thereof. The term “alkali earth metal salt(s)” used herein may comprise one or more selected from calcium salts, strontium salts or barium salts.

The term “soluble” and “insoluble” used herein means soluble or insoluble in aqueous solution, unless indicated otherwise. The term “soluble” denotes salts having solubility in water of equal to more than 0.05 g/liter at 20° C. The term “insoluble” denotes salts having solubility in water of less than 0.05 g/liter at 20° C.

The residue, which is purified according to the process of the present invention, is obtained by, for example, treating by-products from metallurgical manufacture, preferably from steel manufacture, or by treating cement kiln dust from cement production. Cement kiln dust (CKD) is preferably a fine-grained, solid, highly alkali metal waste removed from cement kiln exhaust gas by air pollution control devices. Other residue from an industrial process such as rice hull ashes, ashes of wood combustion plants, ashes of coal combustion plants, cement kiln residue, steel industry dusts, dusts from iron sintering processes, flue dusts from furnace such as glass furnace or cotton processing dusts can be purified using the present process. A suitable treatment may comprise, for example, contacting the residue with aqueous solution to provide a suspension of solids in a solution of water soluble impurities.

The process of the present invention can remove sulfates contained in the residue to make the resulting brine having a high purity. The residue may contain various impurities, including polyvalent metals, inorganic compounds and/or organic compounds as well as sulfates. Such residue may contain impurities from 2 to 99%, preferably from 5 to 99%, more preferably from 10 to 99% by weight of the residue. Further, the sulfate salts may be contained from 1 to 95%, preferably from 3 to 90%, more preferably from 10 to 90% by weight of the residue.

According to the present invention, the amount of aqueous solution needed to dissolve salts is brought into contact with the residue. The aqueous solution may be prepared with substantially pure water or water recycled from an industrial process. The aqueous solution may contain an excess amount of calcium salts. In any case, an excess amount of calcium ions may be needed to obtain the best removal yield. In the process of the present invention, the amount of calcium salts included in the aqueous solution is generally from 1 to 20%, preferably from 2 to 15%, more preferably from 5 to 10% by weight of aqueous solution.

The temperature of the aqueous solution may be adapted to the solubility of soluble salts. It has been observed that the process of the present invention functions especially well when the dissolving step is carried out at a temperature between 5 and 99° C., and preferably between 10 and 80° C. Temperatures between 15 and 60° C., particularly temperatures close to 20° C., e.g., between 18 and 22° C., are suitable.

The aqueous solution may be brought into contact with the residue in various ways as follows.

According to a first embodiment of the invention, the aqueous solution is brought into contact with the residue by introducing the aqueous solution and the residue into a reactor, which is preferably equipped with stirring means to ensure homogeneous mixing. The soluble salts then dissolve in the aqueous solution. The amount of aqueous solution and the residence time in the reactor must be sufficient to obtain the most complete dissolution possible of soluble salts to be regenerated. In the first embodiment, it is recommended that at least 95%, advantageously at least 98%, preferably 99% of these salts are dissolved. It is pointless to add an excessive amount of aqueous solution. It is recommended that this amount does not exceed 1.5 times, preferably 1.25 times the minimum amount of solution needed to dissolve at least 99% of the salts.

According to a second embodiment of the invention, the aqueous solution is brought into contact with the residue by leaching. In this embodiment, the aqueous solution is percolated through a layer constituted with the residue. This layer is generally placed on a filter layer that can prevent the residue particles from being entrained during the percolation into the resulting aqueous suspension. In the second embodiment, it is advantageous for said filter layer to possess separation properties that can perform the separation of the insoluble particles carried out in the second step of the process according to the present invention. It is then possible to carry out the contacting step and the separation step using a single device. It is recommended that the leaching allows the dissolution of at least 50%, advantageously 75%, preferably at least 95%, particularly preferably at least 99% of the salts to be regenerated that are present in the residue. In certain cases, it is possible for the leaching step to be carried out at an industrial site different from that where the rest of the process is carried out.

After dissolving soluble salts and mixing them with residue, the undissolved, mainly insoluble, species and/or precipitates are separated from the aqueous suspension to form the product solution. Any separation means known in the field may be used. Filtration, decantation or centrifugation can be preferably used. When an average diameter of the particles in the suspension is equal to at least 10 μm (as measured by laser diffraction, for example, using a SYMPATEC apparatus), it is possible to use vacuum filters such as rotary filters or belt filters. These filters are recommended when the average diameter of the particles exceeds 50 μm. When the average diameter of the particles is less than 10 μm, horizontal or vertical frame filter presses, cartridge filters or bag filters are preferably used. These filters are also recommended when the average diameter of the particles ranges from 10 to 50 μm. The separation may be preceded by a settling step in order to thicken the suspension to be filtered. The settling step is preferably preceded by a flocculation step.

The residue to be purified according to the present invention may comprise one or more species selected from the group consisting of alkali metal salts, alkali earth metal salts and sulfates. The term “alkali metal salt(s)” used herein means any soluble/insoluble salt(s) containing alkali metal ion, i.e., sodium, potassium, lithium, caesium or francium. By way of example, the alkali metal salts contained in the residue may be selected from: alkali metal halide such as sodium chloride, potassium chloride, sodium fluoride, potassium fluoride, sodium bromide, potassium bromide, sodium iodide and potassium iodide, preferably sodium chloride and potassium chloride; and alkali metal sulfates such as sodium sulfates and potassium sulfates. The alkali earth metal salts contained in the residue may be selected from: alkali earth halide such as calcium chloride, strontium chloride, barium chloride, calcium fluoride, strontium fluoride, barium fluoride, calcium bromide, strontium bromide, barium bromide, calcium iodide, strontium iodide and barium iodide; alkali earth metal sulfates such as calcium sulfates, strontium sulfates and barium sulfates; alkaline earth metal hydroxide such as strontium hydroxide or barium hydroxide; and alkaline earth metal oxide such as strontium oxide or barium oxide. The residue generally may further contain any soluble salts other than those described above.

In some embodiments of the present invention, the residue containing sulfates is suitable and may be removed from the residue by reaction with calcium ions to precipitate calcium sulfates. The excess amount of calcium ions can be removed by reaction with, for example, CO₂, carbonates, hydrogen carbonates or fluorinated salts to precipitate calcium carbonates or calcium fluorides. Strontium and/or barium ions typically contained in the residue can be removed simultaneously by precipitation of strontium carbonates, barium carbonates.

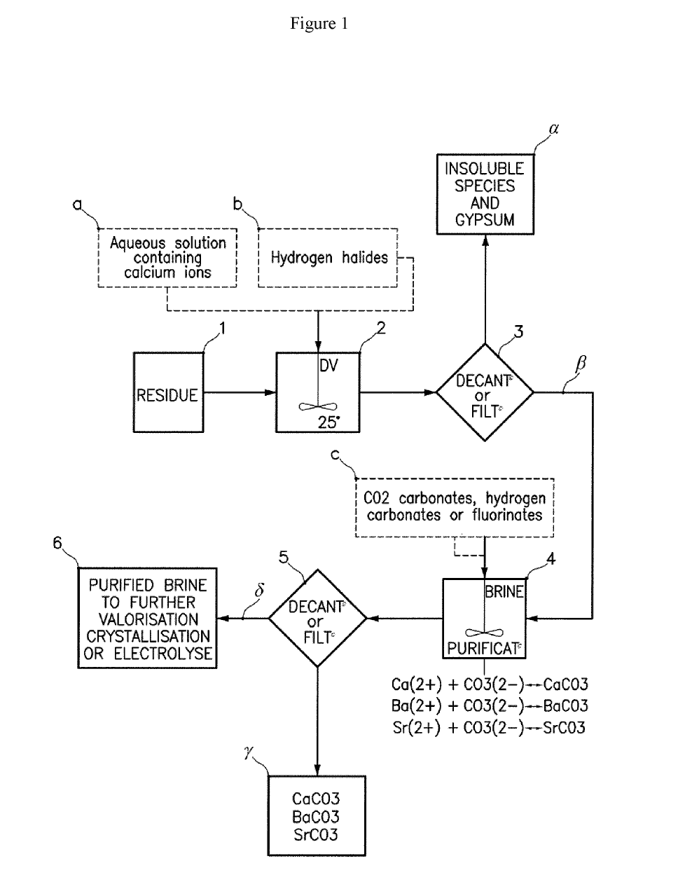

FIG. 1 shows a representative scheme of purification process of the present invention. In some embodiments, the residue is highly concentrated with sulfate salts such as K₂SO₄ or Na₂SO₄. The residue may also comprise other alkali metal salts such as KCl or NaCl, or other alkali earth metal salts such as strontium or barium salts.

To separate salt and insoluble species, the residue (1) is brought into contact with aqueous solution comprising calcium salts (a) in a dissolver (2). At the same time, anions of sulfate salts contained in the residue react with calcium ions contained in the aqueous solution. In any case, an excess amount of calcium salts can be added into the residue to achieve the best removal yield.

In one embodiment, the reaction mechanism is as follows:

CaCl₂+H₂O [symbol] Ca²⁺+2Cl⁻+H₂O (1-1)

SO₄²⁻+Ca²⁺+2Cl⁻+2H₂O [symbol] CaSO₄.2H₂O+2Cl⁻ (1-2)

If insoluble calcium salt may be present in the residue, they may also be removed using the present process. In this case, for example, calcium salts can be hydroxides, oxides or carbonates. If the insoluble calcium salts are used, then hydrogen halides (b) selected from hydrogen chloride, hydrogen fluoride, hydrogen bromide, hydrogen iodide or a mixture thereof, preferably hydrogen chloride, can be added into the suspension to react with insoluble calcium salts. In one embodiment, the reaction mechanisms are as follows:

2HCl+Ca(OH)₂+H₂O [symbol] Ca²⁺+2Cl⁻+3H₂O (2-1)

2HCl+CaO+H₂O [symbol] Ca²⁺+2Cl⁻+2H₂O (2-2)

2HCl+CaCO₃+H₂O [symbol] Ca²⁺+2Cl⁻+2H₂O+CO₃²⁻ (2-3)

SO₄²⁻+Ca²⁺+2Cl⁻+2H₂O [symbol] CaSO₄.2H₂O+2Cl⁻ (1-2)

In the reaction (1-2), insoluble calcium sulfates are precipitated and removed through using a separating method such as filtration, decantation or centrifugation (3). Other insoluble species and/or gypsum produced by the dissolution and reaction may also be removed in this step. Any separating method in this field can be used in lieu of decantation and/or filtration and/or centrifugation.

The dissolution and sulfate precipitation steps can be separated. For example, salts are dissolved into the residue, the suspension is decanted and/or filtrated to remove insoluble species, calcium salts are added, and the suspension is decanted and/or filtrated again to separate gypsums from the residue.

At this step, the clear brine (β) has a low concentration of sulfates and an excess amount of calcium ions. Since the excess amount of calcium ions may cause undesirable effects such as crusting or scaling in the subsequent processes, they need to be removed from the final brine.

To remove the undesired calcium ions, CO₂, carbonates, hydrogen carbonates or fluorinated salts, for example, alkali metal carbonates such as sodium carbonate or potassium carbonate, alkali metal hydrogen carbonates such as sodium hydrogen carbonate or potassium hydrogen carbonate, alkali metal fluorides such as sodium fluoride or potassium fluoride, or a mixture thereof can be added into the brine in the reactor (4). Adding CO₂, carbonates, hydrogen carbonates or fluorinated salts can initiate precipitation of calcium carbonates or calcium fluorides, thereby causing highly purified brine from calcium ions. In this step, the strontium and/or barium ions, which have been contained in the residue, may also be removed from the brine.

The reactions between alkali earth metal cations and CO₂ or carbonate anions are as follows:

Ca²⁺+CO₃²⁻ [symbol] CaCO₃ (3-1)

Ba²⁺+CO₃²⁻ [symbol] BaCO₃ (3-2)

Sr²⁺+CO₃²⁻ [symbol] SrCO₃ (3-3)

The reactions between calcium cations and fluorine anions are as follows:

Ca²⁺+2F⁻ [symbol] CaF₂ (4)

The precipitates (γ) are separated by, for example, decantation and/or filtration (5). Any separating method in this field can be used in lieu of decantation, filtration or centrifugation.

The purified brine has a Ca salt concentration of equal to or lower than 0.015 g/liter solution.

The final purified brine (δ) is ready to be sent to its further application (6) such as crystallization to recover, for example, KCl and/or NaCl, or to electrolysis.

The separated solids can be reused for:
Both salts: electrolysis uses, high quality salts applications such as food, feed, electronics, pharmaceuticals, water remineralisation, water treatment, food preservatives, ceramic glaze, metallurgy, water softeners, regeneration of ion exchange resins, photography, nuclear reactors, etc;
NaCl: soda ash plant raw material; and
KCl: fertilizers, plant nutriments, buffer solutions.

Should the disclosure of any patents, patent applications, and publications which are incorporated herein by reference conflict with the description of the present application to the extent that it may render a term unclear, the present description shall take precedence.

### EXAMPLES

The following examples are intended to illustrate the present invention without limiting the scope of the present invention.

### Example 1 and 2

### STEP 1a

Two tests have been performed with industrial cement kiln dusts. Cement kiln dusts were dissolved in water at 50° C. and then CaCl₂ was added in the suspension. The test conditions are shown in Table 1.

TABLE 1
Test conditions

| Temperature, ° C. | Cement Kiln Dusts, gram | Water | CaCl₂ Addition |
|---|---|---|---|
| 50 | 1428 | 1302 | 14.8 |

### STEP 1b

After CaCl₂ addition and a residence time of about 30 min, suspension was filtered on a Buchner filter equipped with a Millipore 0.45 μm membrane. Compositions of clear solution after filtration are shown in Table 2.

TABLE 2

| | Composition of clear solution after dissolution and CaCl₂ addition | | | | | | | |
|---|---|---|---|---|---|---|---|---|
| | | Ca | Na | K | Cl | SO₄ | Ba | Sr |
| Test 1 | DN/kg solution | 196 | 1716 | 2264 | 3993 | 46 | 0.114 | 1.393 |
| | g/kg solution | 3.930 | 39.468 | 88.522 | 141.752 | 2.213 | 0.0082 | 0.061 |
| Test 2 | DN/kg solution | 177 | 1551 | 2047 | 3610 | 42 | 0.108 | 1.258 |
| | g/kg solution | 3.553 | 35.684 | 47.079 | 83.033 | 0.957 | 0.0074 | 0.0551 |

### STEP 1c

Clear solutions were warmed up to 50° C. and 31.11 g of a 300 g Na₂CO₃/kg solution was mixed into the clear solution. After 35 minutes, colloidal precipitates were identified. The solutions were filtered and the new clear solutions were analyzed again. The compositions of the final brines are shown in Table 3.

TABLE 3

| | | Ca | Na | K | Cl | SO₄ | Ba | Sr |
|---|---|---|---|---|---|---|---|---|
| | Composition of clear solution after dissolution and CaCl₂ addition | | | | | | | |
| Test 1 | DN/kg solution | 196 | 1716 | 2264 | 3993 | 46 | 0.114 | 1.393 |
| | g/kg solution | 3.930 | 39.468 | 88.522 | 141.752 | 2.213 | 0.0082 | 0.061 |
| | Composition of clear solution after Na₂CO₃ addition | | | | | | | |
| | g/kg solution | 0.007 | n.d. | n.d. | n.d. | n.d. | 0.00027 | 0.0017 |
| | Purification | 99.832 | | | | | 96.707 | 97.213 |
| | efficiency | | | | | | | |
| | Composition of clear solution after dissolution and CaCl₂ addition | | | | | | | |
| Test 2 | DN/kg solution | 177 | 1551 | 2047 | 3610 | 42 | 0.108 | 1.258 |
| | g/kg solution | 3.553 | 35.684 | 47.079 | 83.033 | 0.957 | 0.0074 | 0.0551 |
| | Composition of clear solution after Na₂CO₃ addition | | | | | | | |
| | g/kg solution | 0.006 | n.d. | n.d. | n.d. | n.d. | 0.0003 | 0.0015 |
| | Purification | 99.828 | | | | | 95.946 | 97.278 |
| | efficiency % | | | | | | | |

Note:
n.d. = non determined

TABLE 4
Balance on Na₂CO₃ during the tests

| | Na₂CO₃ balance | | | | |
|---|---|---|---|---|---|
| | | | Concen- | | Intro- |
| | | | tration | amount of | duced, |
| | | | g/kg solution | solution, g | g |
| Test | Na₂CO₃ introduced | | 300 | 0.0312 | 9.36 |
| 1 | Mass of brine treated | kg | 0.905 | | |
| | Species to remove | | Ca | Ba | Sr |
| | Concentration | g/kg | 3.93 | 0.0082 | 0.06 |
| | Amount to remove | g | 3.56 | 0.01 | 0.06 |
| | Na₂CO₃ needed at | g | 9.41 | 0.01 | 0.07 |
| | stoichiometric | | | | |
| | Total Na₂CO₃ needed | g | 9.48 | | |
| | at stoichiometric | | | | |
| | Na₂CO₃ excess | | 0.99 | | |
| | Na₂CO₃ introduced | | 300 | 0.0312 | 9.36 |
| | Mass of brine treated | kg | 0.905 | | |
| | Species to remove | | Ca | Ba | Sr |
| | Concentration | g/kg | 3.553 | 0.0074 | 0.06 |
| | Amount to remove | g | 3.22 | 0.01 | 0.05 |
| | Na₂CO₃ needed at | g | 8.50 | 0.01 | 0.06 |
| | stoichiometric | | | | |

| | | |
|---|---|---|
| Total Na₂CO₃ needed | g | 8.57 |
| at stoichiometric | | |
| Na₂CO₃ excess | | 1.09 |

More than 99.8% of Ca, 95.9% of Ba and 97.2% of Sr were removed with a stoichiometric between 0.99 and 1.09.

### Example 3

Another test was conducted with another solution prepared with the same procedure as above Steps 1a and 1b.

At Step 1c, clear solution was warmed up to 50° C. and 57.5 grams of a 299 g Na₂CO₃/kg solution was mixed into the clear solution. After 35 minutes, colloidal precipitate was identified. The solution was filtered and the new clear solution was analyzed again. The composition of the final brine is shown in Table 5.

TABLE 5

| | | | |
|---|---|---|---|
| Test 3 | Ca | Ba | Sr |

Composition of clear solution after
dissolution and CaCl₂ addition

| | | | |
|---|---|---|---|
| mg/kg solution | 4000 | 8.3 | 56 |

Composition of clear solution after Na₂CO₃
addition

| | | | |
|---|---|---|---|
| mg/kg solution | 3.500 | 0.08 | 0.28 |
| Purification | 99.913 | 99.036 | 99.500 |
| efficiency % | | | |

TABLE 6
Balance on Na₂CO₃ during the test

| | Na₂CO₃ balance | | | | |
|---|---|---|---|---|---|
| | | | Concen- | | |
| | | | tration | | |
| | | | g/kg | amount of | Introduced |
| | | | solution | solution g | g |
| Test 3 | Na₂CO₃ introduced | | 299 | 0.0575 | 17.1925 |
| | Mass of brine | kg | 1,626 | | |
| | treated | | | | |
| | Species to remove | | Ca | Ba | Sr |
| | Concentration | g/kg | 4.000 | 0.0083 | 0.06 |
| | Amount to remove | g | 6.50 | 0.01 | 0.09 |
| | Na₂CO₃ needed | g | 17.19 | 0.01 | 0.11 |
| | at stoichiometric | | | | |

| | | |
|---|---|---|
| Total Na₂CO₃ | G | 17.31 |
| needed at | | |
| stoichiometric | | |
| Na₂CO₃ excess | | 0.99 |

More than 99.9% of Ca, 99% of Ba and 99.5% of Sr were removed with a stoichiometric of 0.99.

1. A method of purifying a residue from an industrial process using calcium ions to obtain a purified brine, comprising:
(a) mixing the residue comprising sulfate salts from the industrial process with calcium salts;
(b) separating insoluble species and/or precipitates from the suspension from (a);
(c) adding an agent capable of precipitating calcium salts from the filtrate from (b) into the filtrate from (b) to remove excess calcium ions; and
(d) separating precipitates from the suspension from (c) to obtain a purified brine.

2. The method of claim 1, wherein the sulfate salts comprise one or more alkali metal salts.

3. The method of claim 16, wherein at least one of the carbonates, hydrogen carbonates or fluorinated salts are alkali metal salts.

4. The method of claim 1, wherein calcium salts are added with an amount of from 1 to 20% by weight of aqueous solution in step (a).

5. The method of claim 1, wherein the residue contains one or more species selected from the group consisting of alkali metal salts and alkali earth metal salts.

6. The method of claim 20, wherein the strontium and/or barium salts are removed in step (c).

7. The method of claim 1, wherein the calcium salts are soluble in the aqueous solution.

8. The method of claim 20, wherein the strontium salts are soluble in the aqueous solution.

9. The method of claim 20, wherein the barium salts are soluble in the aqueous solution.

10. The method of claim 1, wherein calcium salts are insoluble in the aqueous solution.

11. The method of claim 20, wherein the strontium salts are insoluble in the aqueous solution.

12. The method of claim 20, wherein the barium salts are insoluble in the aqueous solution.

13. The method of claim 10, further comprising the step of adding hydrogen halide into the suspension from (a) prior to separating.

14. The method of claim 1, wherein the residue originates from rice hull ashes, ashes of wood combustion plants, ashes of coal combustion plants, cement kiln dusts, steel industry dusts, iron sintering processes dusts, flue dusts from a furnace, or cotton processing dusts.

15. The method of claim 1, wherein the purified brine is subjected to at least one further step selected from the group consisting of crystallization and electrolysis.

16. The method of claim 1, wherein the agent capable of precipitating calcium salts is selected from one of more of CO₂, carbonates, hydrogen carbonates, or fluorinated salts.

17. The method of claim 2, wherein the one or more alkali metal salts comprise potassium sulfate or sodium sulfate.

18. The method of claim 3, wherein the alkali metal salts comprise sodium carbonate, potassium carbonate, sodium hydrogen carbonate, potassium hydrogen carbonate, sodium fluoride, potassium fluoride, or a mixture thereof.

19. The method of claim 5, wherein the alkali metal salts comprise NaCl, KCl, Na₂SO₄ or K₂SO₄.

20. The method of claim 5, wherein the alkali earth metal salts comprise strontium or barium salts.
